(19) United States
(12) Patent Application Publication
(10) Pub. No.: US 2014/0181735 A1
(43) Pub. Date: Jun. 26, 2014

(54) ELECTRONIC DEVICE AND METHOD FOR CONTROLLING LOCATION OF TOOLTIP DISPLAYED ON DISPLAY SCREEN

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHENG-FENG TSAI, New Taipei (TW)

(73) Assignee: HON HAI PRECISION INDUSTRY CO., LTD., New Taipei (TW)

(21) Appl. No.: 14/092,903

(22) Filed: Nov. 27, 2013

(30) Foreign Application Priority Data
Dec. 24, 2012 (TW) 101149418

(51) Int. Cl. G06F 3/0485

(52) U.S. Cl. CPC G06F 3/0485
USPC 715/786

(57) ABSTRACT

In a method for controlling a location of a tooltip of a user interface, the user interface is displayed on a display screen of an electronic device, and the tooltip is displayed in a display location of the display screen when a target item is selected from the user interface. The method calculates a shortest distance between the tooltip and the target item displayed on the display screen when the target item is fully presented on the display screen, and scrolls a scrollbar of the user interface within the shortest distance for displaying the tooltip presented on the display screen. The method triggers scrolls the scrollbar to display the tooltip beside the target item when there is a spare space beside the target item.

### BACKGROUND

1. Technical Field

Embodiments of the present disclosure relate to information display systems and methods, and particularly to an electronic device and method for controlling a location of a tooltip displayed on a display screen of the electronic device.

2. Description of Related Art

When a user uses a new software system, tooltips help the user understand functions of the software system. For example, related descriptions of a target item are presented in the tooltip when the user selects a target item displayed on a user interface of the software system. However, the tooltip may cover other display contents of the user interface, and it is inconvenient for the user to view other display contents of the user interface. Therefore, there is room for improvement within the prior art.

### BRIEF DESCRIPTION OF THE DRAWINGS

FIG. 1 is a block diagram of one embodiment of an electronic device including a tooltip display system.

FIG. 2 is a flowchart of one embodiment of a method for controlling a tooltip displayed on a display screen of the electronic device.

FIG. 3 shows an exemplary embodiment of a user interface on the display screen.

FIG. 4 shows an exemplary embodiment of a tooltip displayed in an initial location of the display screen.

FIG. 5 shows an exemplary embodiment of the tooltip not covering a target item of the user interface.

FIG. 6 shows an exemplary embodiment of the tooltip covering a target item of the user interface.

FIG. 7 shows an exemplary embodiment of the tooltip not overlapping a target item of the user interface.

FIG. 8 shows an exemplary embodiment of the tooltip overlapping a target item of the user interface.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

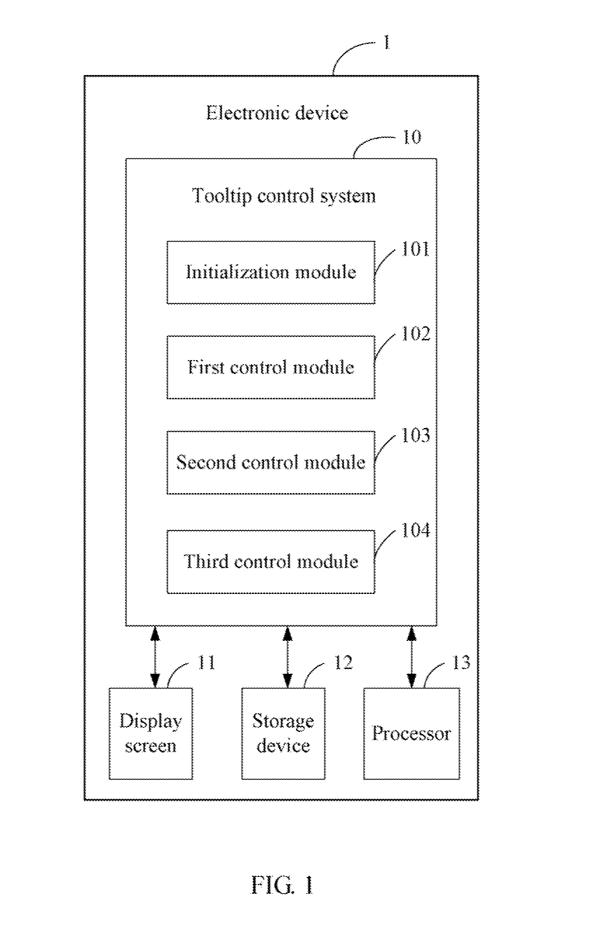

FIG. 1 is a block diagram of one embodiment of an electronic device 1 including a tooltip control system 10. In the embodiment, the tooltip display system 10 comprises computerized instructions in the form of one or more computer-readable programs, which are implemented by the electronic device 1. The electronic device 1 includes, but is not limited to, a display screen 11, a storage device 12, and at least one processor 13. The electronic device 1 can be a personal computer, a server computer, a notebook computer, a mobile phone, a personal digital assistant (PDA), or the like.

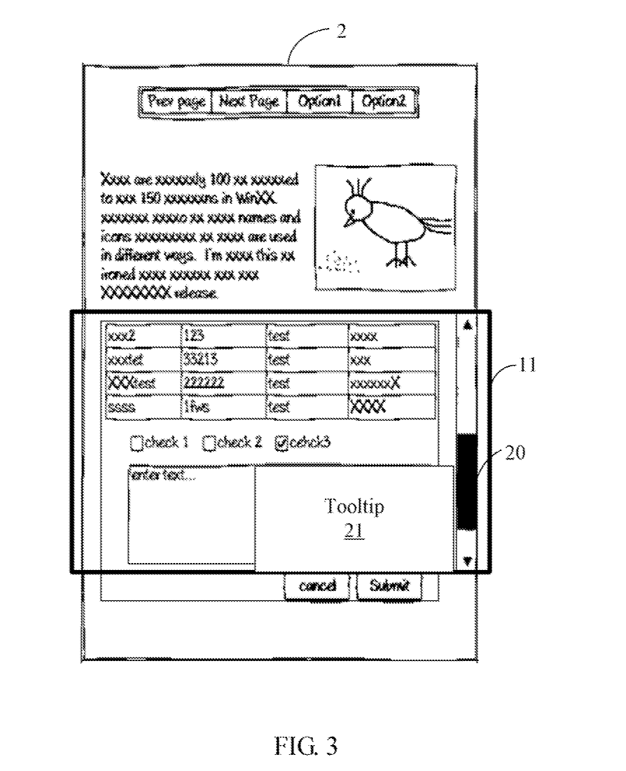

The tooltip display system 10 displays a tooltip on the display screen 11 when a target item of the user interface is selected by a user, and controls a display location of the tooltip on the display screen 11. In one embodiment, the tooltip shows related descriptions of the selected target item to the user. The user interface is displayed on the display screen 11 and may include a plurality of target items, such as files, pictures, tables, text boxes, functional buttons, and the like. FIG. 3 shows an exemplary user interface 2 on the display screen 11. A display resolution of the display screen 11 can be 1024*768 pixels, but a display size of the user interface 2 can be 1024*2068 pixels. Thus, only a part of the user interface 2 (i.e., the display area 3) is displayed on the display screen 11, and the user must operate a scroll bar 20 of the user interface 2 to view the rest of the user interface 2.

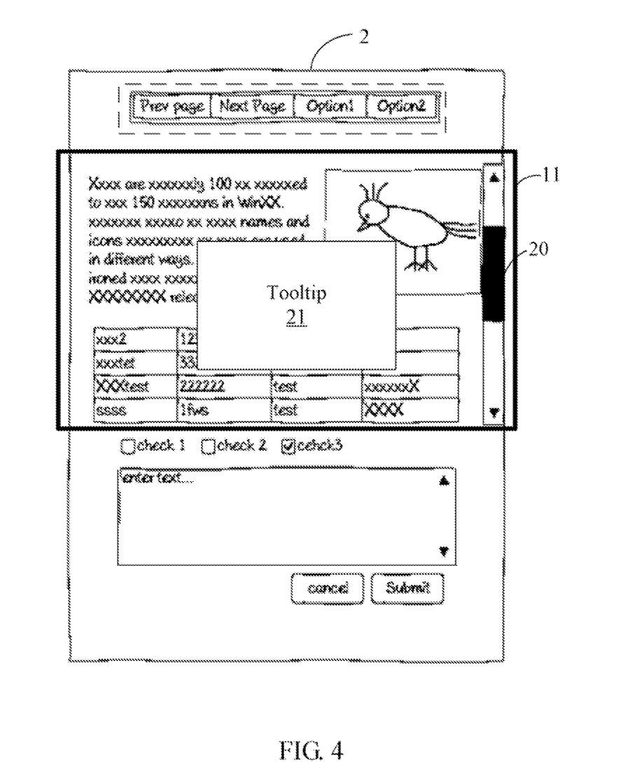

Referring to FIG. 4, a tooltip 21 is displayed on the user interface 2 of the display screen 11. The tooltip 21 shows related descriptions of a target item when the user selects the target item from the user interface 2. The target item may include, but is not limited to, a tool bar, a picture, a text box, or a functional button. If the user selects a picture in the user interface 2, related descriptions of the selected picture are displayed in the tooltip 21.

The display screen 11 displays the user interface 2 and the tooltip 21 of a target item in the user interface when the target item is selected by the user. The storage device 12 can be an internal storage system, such as a flash memory, a random access memory (RAM) for temporary storage of information, and/or a read only memory (ROM) for permanent storage of information. The storage device 12 can also be an external storage system, such as an external hard disk, a storage card, or a data storage medium. The at least one processor 13 is a central processing unit (CPU) or microprocessor that performs various functions of the electronic device 1.

In one embodiment, the tooltip display system 10 includes an initialization module 101, a first control module 102, a second control module 103, and a third control module 104. The modules 101-104 can comprise computerized instructions in the form of one or more computer-readable programs that are stored in a non-transitory computer-readable medium (such as the storage device 12) and executed by the at least one processor 13. A description of each module is given in the following paragraphs.

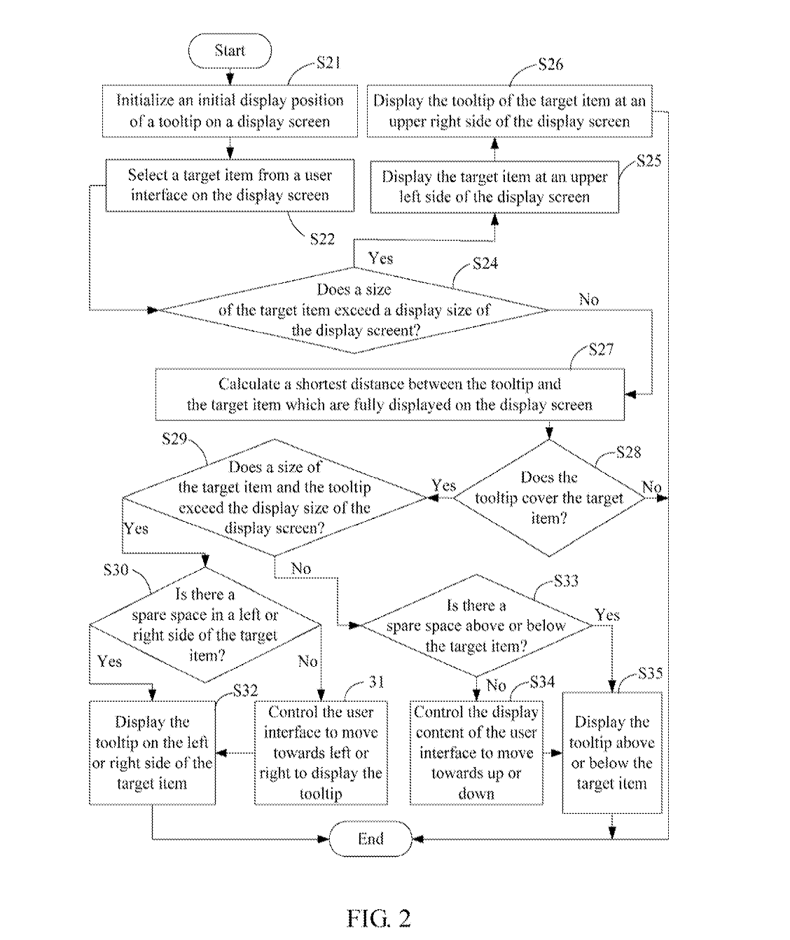

FIG. 2 is a flowchart of one embodiment of a method for controlling a tooltip displayed on a display screen of the electronic device 1. In one embodiment, the method is performed by execution of computer-readable software program codes or instructions by the at least one processor 13 of the electronic device 1. The method displays a tooltip on a user interface presented on the display screen 11 when a target item of the user interface is selected by a user, and further controls a display location of the tooltip on the display screen 11. Depending on the embodiment, additional steps may be added, others removed, and the ordering of the steps may be changed.

In step S21, the initialization module 101 initializes an initial display location of the tooltip 21 on the display screen 11. In one example as shown in FIG. 4, the initialization module 101 initializes a central location of the display screen 11 as the initial display location of the tooltip 21.

In step S22, the initialization module 101 displays the tooltip 21 in the initial display location when the target item is selected from the user interface 2. Referring to FIG. 4, if the target item is a tool bar, the tooltip 21 of the tool bar is displayed in the initial display location.

In step S24, the first control module 102 determines whether a size of the target item is greater than the display size of the display screen 11. If the size of the target item is greater than the display size of the display screen 11, step S25 is implemented. If the size of the target item is not greater than the display size of the display screen 11, step S26 is implemented.

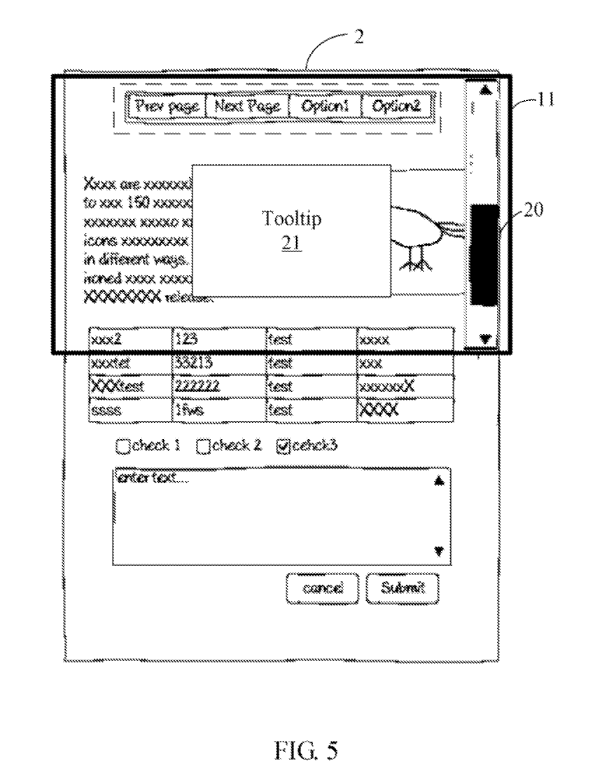

In step S25, the first control module 102 adjusts the user interface 2 so that the target item is displayed at an upper left side of the display screen 11. Referring to FIG. 5, the target item (e.g., the toolbar) is displayed at a top of the display screen 11.

In step S26, the first control module 102 displays the tooltip 21 of the target item at an upper right side of the display screen 11. Referring to FIG. 5, the tooltip 21 is displayed below the tool bar in the display screen 11.

In step S27, the first control module 102 calculates a shortest distance between the tooltip 21 and the target item displayed on the display screen 11 simultaneously. In the embodiment, the shortest distance indicates that the tooltip 21 is displayed nearest from the target item. Referring to FIG. 4, if the target item is the toolbar of the user interface 2 which is not displayed on the display screen 11, the visual range of the display screen 11 moves up by scrolling the scroll bar 20. Further referring to FIG. 5, the toolbar is displayed on the display screen 11 and selected by the user, and the tooltip 21 of the toolbar may be displayed on the initial display location, that is, the center location of the display screen 11.

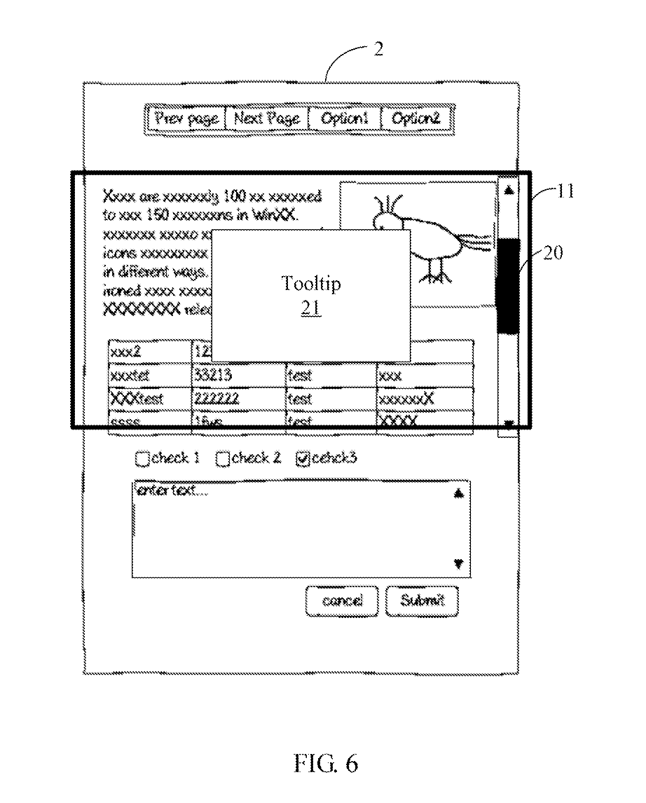

In step S28, the second control module 103 determines whether the tooltip 21 covers the selected target item (e.g., the toolbar of the user interface 2). If the tooltip 21 covers the selected target item, step S29 is implemented. Otherwise, if the tooltip 21 does not cover the selected target item, the procedure ends. Referring to FIG. 5, the tooltip 21 does not cover the toolbar of the user interface 2. Referring to FIG. 6, the tooltip 21 covers the picture (i.e., the bird picture) of the user interface 2.

In step S29, the third control module 104 determines whether the size of the target item and the size of the tooltip 21 exceed the display size of the display screen 11. If the size of the target item and the size of the tooltip 21 exceed the display size of the display screen 11, step S30 is implemented. If the size of the target item and the size of the tooltip 21 do not exceed the display size of display screen 11, step S33 is implemented.

In step S30, the third control module 104 determines whether there is a spare space a left or a right side of the target item to fully display the tooltip 21. If there is no spare space in the left or the right side of the target item to display the tooltip 21, step S31 is implemented. If there is the spare space in the left or right side of the target item to display the tooltip 21, step S32 is implemented.

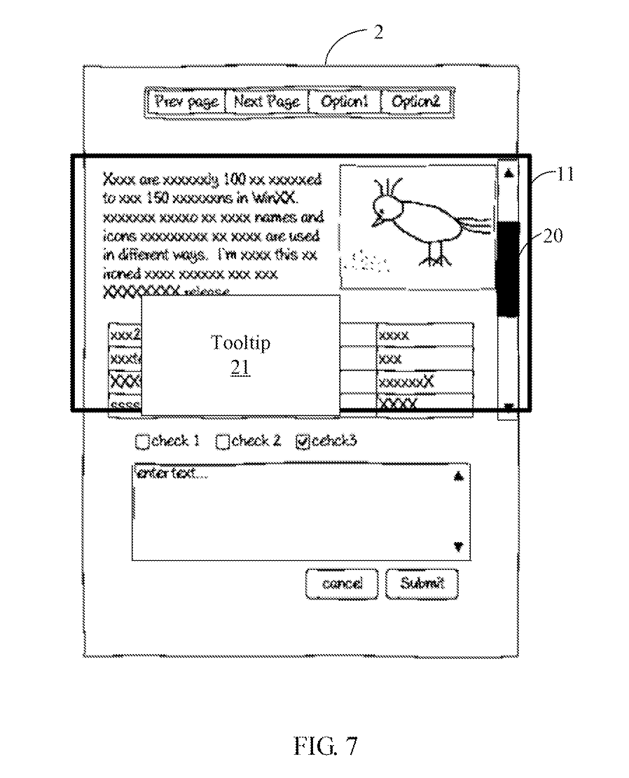

In step S31, the third control module 104 triggers a browsing event to scroll the scrollbar 20 to control the display content of the user interface 2 to move towards left or right to display the tooltip 21. Referring to FIG. 7, a visual range of the display screen 11 is moved up by scrolling the scroll bar 20 of the user interface 2, and the target item (e.g., the bird picture) is displayed in the upper right location of the display screen 11.

In step S32, the third control module 104 triggers the browsing event to scroll the scrollbar 20 to display the tooltip 21 on the left or right side of the target item. Referring to FIG. 7, the visual range of the display screen 11 is moved down by scrolling the scroll bar 20 of the user interface 2, and the target item (e.g., the bird picture) is displayed in the bottom right location of the display screen 11.

In step S33, the third control module 104 determines whether there is a spare space above or below the target item to display the tooltip 21. If there is no spare space above or below the target item to display the tooltip 21, step S34 is implemented. If there is a spare space above or below the target item to display the tooltip 21, step S35 is implemented.

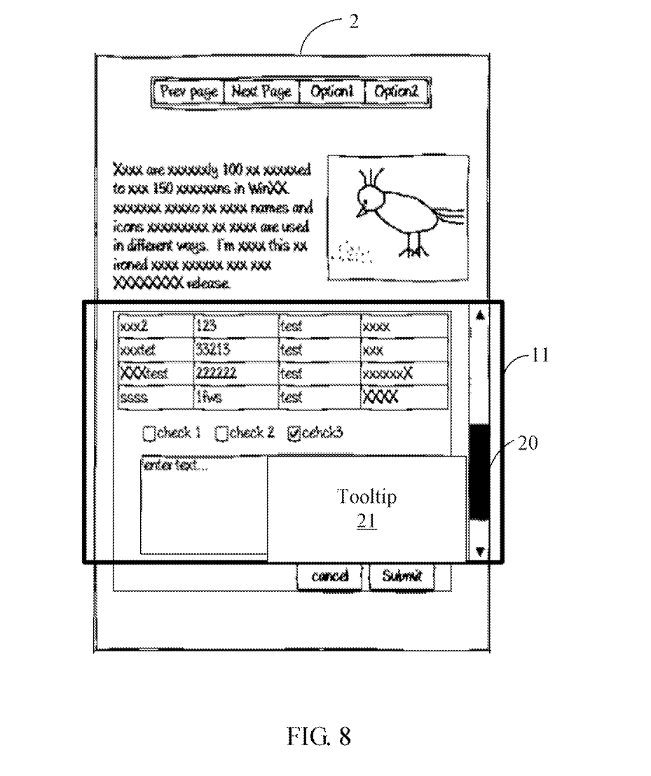

In step S34, the third control module 104 triggers the browsing event to scroll the scrollbar 20 to control the display content of the user interface 2 to move towards up or down. Referring to FIG. 8, the visual range of the display screen 11 is moves down by scrolling the scroll bar 20 of the user interface 2, and the target item (e.g., the text box) is displayed at the top left side of the display screen 11.

In step S35, the third control module 104 triggers the browsing event to scroll the scrollbar 20 to display the tooltip 21 above or below the target item. Referring to FIG. 8, the visual range of the display screen 11 is moved down by scrolling the scroll bar 20 of the user interface 2, and the target item (e.g., the text box) is displayed at the top right side of the display screen 11.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A electronic device, comprising:
a display screen and at least one processor; and
a storage device storing a computer-readable program including instructions that, which when executed by the at least one processor, causes the at least one processor to:
display a tooltip on an initial display location of the display screen when a target item is selected from a user interface displayed on the display screen;
calculate a shortest distance between the tooltip and the selected target item which are fully displayed on the display screen;
scroll a scrollbar of the user interface within the shortest distance for displaying the tooltip on the display screen;
control the tooltip to display the initial display location on the display screen;
determine whether there is a spare space beside the target item to display the tooltip on the display screen;
scroll the scrollbar of the user interface for displaying the tooltip beside the target item if there is the spare space beside the target item; and
scroll the scrollbar of the user interface for displaying the tooltip overlapping least the target item if there is no spare space beside the target item.

2. The electronic device according to claim 1, wherein the computer-readable program further causes the at least one processor to:
determine whether a size of the target item is greater than a size of the display screen; and
scroll the scrollbar of the user interface to display the target item on an upper left side of the display screen and display the tooltip on an upper right side of the display screen, when the size of the target item is greater than the size of the display screen.

3. The electronic device according to claim 1, wherein the computer-readable program further causes the at least one processor to:
determine whether a size of the target item and a size of the tooltip exceed a display size of the display screen;
determine whether there is a spare space on a left or right side of the target item to display the tooltip, if the size of the target item and the size of the tooltip exceed the display size of the display screen; and
determine whether there is a spare space above or below the target item to display the tooltip, if the size of the target item and the size of the tooltip do not exceed the display size of the display screen.

4. The electronic device according to claim 3, wherein the computer-readable program further causes the at least one processor to:
control display content of the user interface to move towards left or right to the display screen and display the tooltip on the left or right side of the target item, if there is no spare space above or below the target item to display the tooltip.

5. The electronic device according to claim 3, wherein the computer-readable program further causes the at least one processor to:
control display content of the user interface to move towards up or down to the display screen and display the tooltip on the left or right side of the target item, if there is no spare space above or below the target item to display the tooltip.

6. The electronic device according to claim 1, wherein the tooltip shows related description of the selected target item, and the user interface comprises a plurality of target items comprising files, pictures, tables, text boxes, and functional buttons.

7. A method for controlling a location of a tooltip of a user interface displayed on a display screen of an electronic device, the method comprising:
displaying the tooltip on an initial display location of the display screen when a target item is selected from a user interface displayed on the display screen;
calculating a shortest distance between the tooltip and the selected target item which are fully displayed on the display screen;
scrolling a scrollbar of the user interface within the shortest distance for displaying the tooltip on the display screen;
controlling the tooltip to display the initial display location on the display screen;
determining whether there is a spare space beside the target item to display the tooltip on the display screen;
scrolling the scrollbar of the user interface for displaying the tooltip beside the target item if there is the spare space beside the target item; and
scrolling the scrollbar of the user interface for displaying the tooltip overlapping least the target item if there is no spare space beside the target item.

8. The method according to claim 7, further comprising:
determining whether a size of the target item is greater than a display size of the display screen; and
scrolling the scrollbar of the user interface to display the target item on an upper left side of the display screen and display the tooltip on an upper right side of the display screen, when the size of the target item is greater than the display size of the display screen.

9. The method according to claim 7, further comprising:
determining whether a size of the target item and a size of the tooltip exceed a display size of the display screen;
determining whether there is a spare space on a left or right side of the target item to display the tooltip, if the size of the target item and the size of the tooltip exceed the display size of the display screen; and
determining whether there is a spare space above or below the target item to display the tooltip, if the size of the target item and the size of the tooltip do not exceed the display size of the display screen.

10. The method according to claim 9, further comprising:
controlling display content of the user interface to move towards left or right to the display screen and display the tooltip on the left or right side of the target item, if there is no spare space above or below the target item to display the tooltip.

11. The method according to claim 9, further comprising:
controlling display content of the user interface to move towards up or down to the display screen and display the tooltip on the left or right side of the target item, if there is no spare space in above or below the target item to display the tooltip.

12. The method according to claim 7, wherein the tooltip shows related description of the selected target item, and the user interface comprises a plurality of target items comprising files, pictures, tables, text boxes, and functional buttons.

13. A non-transitory storage medium having stored thereon instructions that, when executed by at least one processor of an electronic device, causes the processor to perform a method for controlling a location of a tooltip of a user interface displayed on a display screen of the electronic device, the method comprising:
displaying the tooltip on an initial display location of the display screen when a target item is selected from a user interface displayed on the display screen;
calculating a shortest distance between the tooltip and the selected target item which are fully displayed on the display screen;
scrolling a scrollbar of the user interface within the shortest distance for displaying the tooltip on the display screen;
controlling the tooltip to display the initial display location on the display screen;
determining whether there is a spare space beside the target item to display the tooltip on the display screen;
scrolling the scrollbar of the user interface for displaying the tooltip beside the target item if there is the spare space beside the target item; and
scrolling the scrollbar of the user interface for displaying the tooltip overlapping least the target item if there is no spare space beside the target item.

14. The storage medium according to claim 13, wherein the method further comprises:
determining whether a size of the target item is greater than a size of the display screen; and
scrolling the scrollbar of the user interface to display the target item on an upper left side of the display screen and display the tooltip on an upper right side of the display screen, when the size of the target item is greater than the size of the display screen.

15. The storage medium according to claim 13, wherein the method further comprises:
determining whether a size of the target item and a size of the tooltip exceed a display size of the display screen;
determining whether there is a spare space on left or right side the target item to display the tooltip, if the size of the target item and the size of the tooltip exceed the display size of the display screen; and
determining whether there is a spare space above or below the target item to display the tooltip, if the size of the target item and the size of the tooltip do not exceed the display size of the display screen.

16. The storage medium according to claim 16, wherein the method further comprises:
controlling display content of the user interface to move towards left or right to the display screen and display the tooltip in the left or right side of the target item, if there is no spare space above or below the target item to display the tooltip.

17. The storage medium according to claim 16, wherein the method further comprises:
controlling display content of the user interface to move towards up or down to the display screen and display the tooltip in the left or right location of the target item, if there is no spare space above or below the target item to display the tooltip.

18. The storage medium according to claim 13, wherein the tooltip shows related description of the selected target item, and the user interface comprises a plurality of target items comprising files, pictures, tables, text boxes, and functional buttons.
